(19) United States
(12) Patent Application Publication
(10) Pub. No.: US 2012/0056593 A1
(43) Pub. Date: Mar. 8, 2012

(54) CHARGE/DISCHARGE CONTROL CIRCUIT AND BATTERY DEVICE

(76) Inventors: Atsushi Sakurai, Chiba-shi (JP); Toshiyuki Koike, Chiba-shi (JP); Kazuaki Sano, Chiba-shi (JP); Fumihiko Maetani, Chiba-shi (JP)

(21) Appl. No.: 13/209,671

(22) Filed: Aug. 15, 2011

(30) Foreign Application Priority Data
Sep. 8, 2010 (JP) 2010-201122

(51) Int. Cl. H02J 7/00

(52) U.S. Cl. 320/134

(57) ABSTRACT

Provided is a battery device including, in a charge/discharge protection circuit for controlling charge/discharge of a secondary battery by a single bidirectionally conductive field effect transistor, a charge/discharge control circuit with which the layout area is reduced and a leakage current of the bidirectionally conductive field effect transistor is reduced to perform stable operation. The charge/discharge control circuit includes: a switch circuit for controlling a gate of the bidirectionally conductive field effect transistor based on an output of a control circuit for controlling the charge/discharge of the secondary battery; and two Schottky barrier diodes for preventing back-flow of a charge current and a discharge current. The first Schottky barrier diode has a cathode connected to a drain of the bidirectionally conductive field effect transistor, and the second Schottky barrier diode has a cathode connected to a source of the bidirectionally conductive field effect transistor.

### RELATED APPLICATIONS

This application claims priority under 35 U.S.C. §119 to Japanese Patent Application No. 2010-201122 filed on Sep. 8, 2010, the entire content of which is hereby incorporated by reference.

### BACKGROUND OF THE INVENTION

1. Field of the Invention

The present invention relates to a charge/discharge control circuit for detecting a voltage and an abnormality of a secondary battery and to a battery device including the charge/discharge control circuit, and more particularly, to a charge/discharge control circuit capable of control by a single charge/discharge control MOSFET and to a battery device including the charge/discharge control circuit.

2. Description of the Related Art

FIG. 3 illustrates a circuit diagram of a battery device including a conventional charge/discharge control circuit. In the battery device including the conventional charge/discharge control circuit, an enhancement mode N-channel MOSFET 306 capable of bidirectional energization/interruption is connected in series to a negative terminal of a secondary battery 101. A charge circuit or a load is connected to terminals 120 and 121, and a charge/discharge current is supplied or discharged to or from the secondary battery 101 via the terminals 120 and 121. A control circuit 102 detects a voltage of the secondary battery 101 and a voltage of the enhancement mode N-channel MOSFET 306, and controls ON/OFF of switches 301, 304, and 305 based on the detected values. When a potential of a gate terminal of the enhancement mode N-channel MOSFET 306 is equal to or higher than a positive threshold voltage, the enhancement mode N-channel MOSFET 306 provides bidirectional energization between the drain terminal and the source terminal thereof. When the potential of the gate terminal is lower than the threshold voltage, the enhancement mode N-channel MOSFET 306 enters the OFF state between the drain terminal and the source terminal.

A charge-inhibited state is described. When a charger is connected between the terminals 120 and 121, a voltage Vds between the drain terminal and the source terminal of the enhancement mode N-channel MOSFET 306 has a positive value. The control circuit 102 detects that the voltage Vds is positive, and turns ON the switch 301 and OFF the switches 305 and 304. Accordingly, the gate terminal of the enhancement mode N-channel MOSFET 306 has a voltage higher than that of the source terminal thereof by the voltage of the secondary battery 101, with the result that the enhancement mode N-channel MOSFET 306 enters the energized state.

When the secondary battery 101 is charged and the battery voltage reaches a set upper limit value, the control circuit 102 turns OFF the switch 301 and ON the switches 305 and 304. Then, the gate terminal of the enhancement mode N-channel MOSFET 306 has the same potential as that of the source terminal thereof, with the result that the enhancement mode N-channel MOSFET 306 enters the OFF state. As a result, the charge current is interrupted to prevent overcharge of the secondary battery 101. Further, at this time, a diode 302 is reverse-biased to prevent the current from flowing through the switch 304 and the switch 305.

When the charge current is interrupted, no voltage drop by internal resistance occurs and the voltage of the secondary battery 101 reduces. In order to prevent the re-start of charge in response to the voltage reduction, after the charge is inhibited, the charge-inhibited state is maintained until the secondary battery 101 is discharged to some extent to have a voltage that is equal to or lower than a set value. Under the charge-inhibited state, if a load is connected between the terminals 120 and 121, the voltage Vds is switched from positive to negative. The control circuit 102 is thus configured to control the switches 301, 304, and 305 so that the secondary battery 101 may be discharged when the voltage Vds is negative and that the charge current may be interrupted when the voltage Vds is positive.

In the above description, the switches 304 and 305 are both turned ON at the time of the stop of charge. However, the charge can be stopped similarly even if the switch 304 is turned OFF. The first reason is that the switch 305 is ON regardless of ON/OFF of the switch 304, and hence the gate terminal of the enhancement mode N-channel MOSFET 306 has the same potential as that of the source terminal thereof and the enhancement mode N-channel MOSFET 306 thus enters the OFF state. The second reason is that the diode 302 also interrupts the current flowing through the switches 304 and 305.

Note that, the switches 304 and 305 are both OFF at the time of the charge described above and at the time of the discharge to be described later. Accordingly, if the switches 304 and 305 are both turned ON at the time of the stop of charge and the switches 304 and 305 are both turned ON also at the time of the stop of discharge as described later, the two switches are turned ON or OFF simultaneously all the time. It is therefore not necessary to control the switches 304 and 305 independently, which can simplify the configuration of the control circuit 102.

Next, a discharge-inhibited state is described. When a load is connected between the terminals 120 and 121, the voltage Vds between the drain terminal and the source terminal of the enhancement mode N-channel MOSFET 306 has a negative value. The control circuit 102 detects that the voltage Vds is negative, and turns ON the switch 301 and OFF the switches 304 and 305. Accordingly, the gate terminal of the enhancement mode N-channel MOSFET 306 has a voltage higher than that of the drain terminal thereof by the voltage of the secondary battery 101, with the result that the enhancement mode N-channel MOSFET 306 enters the energized state.

When the discharge of the secondary battery 101 progresses and the battery voltage reaches a set lower limit value, the control circuit 102 turns OFF the switch 301 and ON the switches 304 and 305. Then, the gate terminal of the enhancement mode N-channel MOSFET 306 has the same potential as that of the drain terminal thereof, with the result that the enhancement mode N-channel MOSFET 306 enters the OFF state. As a result, the discharge current is interrupted to prevent overdischarge of the secondary battery 101. Further, at this time, a diode 303 is reverse-biased to prevent the current from flowing through the switch 304 and the switch 305.

When the discharge current is interrupted, no voltage drop by internal resistance occurs and the voltage of the secondary battery 101 increases. In order to prevent the re-start of discharge in response to the voltage increase, after the discharge is inhibited, the discharge-inhibited state is maintained until the secondary battery 101 is charged to some extent to have a voltage that is equal to or higher than a set value. Under the discharge-inhibited state, if the charge circuit is connected between the terminals 120 and 121, the voltage Vds is switched from negative to positive. The control circuit 102 is thus configured to control the switches 301, 304, and 305 so that the secondary battery 101 may be charged when the voltage Vds is positive and that the discharge current may be interrupted when the voltage Vds is negative.

In the above description, the switches 304 and 305 are both turned ON at the time of the stop of discharge. However, the discharge can be stopped similarly even if the switch 305 is turned OFF. The first reason is that the switch 304 is ON regardless of ON/OFF of the switch 305, and hence the gate terminal of the enhancement mode N-channel MOSFET 306 has the same potential as that of the drain terminal thereof and the enhancement mode N-channel MOSFET 306 thus enters the OFF state. The second reason is that the diode 303 also interrupts the current flowing through the switches 305 and 304.

Note that, if the switches 304 and 305 are both turned ON at the time of the stop of discharge, as described above, the two switches are turned ON or OFF simultaneously all the time. It is therefore not necessary to control the switches 304 and 305 independently, which can simplify the configuration of the control circuit 102.

The enhancement mode N-channel MOSFET 306 has built-in diodes 321 and 322 formed therein. However, the diodes 321 and 322 are connected in series in opposite directions and hence are not electrically connected to each other, which has no influence on the protection operation described above.

The enhancement mode N-channel MOSFET 306 may be of either a lateral structure or a vertical structure. In the case of the lateral structure, it is easy to form the enhancement mode N-channel MOSFET 306 and the control circuit 102 as a single IC. Therefore, the reduction in size and cost can be achieved because the overcharge/overdischarge protection circuit, which has heretofore been formed by a single IC and two switches, can be formed by a single IC. On the other hand, in the case of the vertical structure, the reduction in loss can be achieved as compared to the lateral structure (see, for example, Japanese Patent Application Laid-open No. 2000-102182 (FIG. 9)).

The conventional technology, however, has a problem that the number of elements is large and the layout area is large. Further, the gate voltage of the enhancement mode N-channel MOSFET 306 can be reduced to no more than the source or drain voltage plus VF (about 0.6 V), and hence there is another problem that a leakage current is large when the enhancement mode N-channel MOSFET 306 is OFF.

### SUMMARY OF THE INVENTION

The present invention has been made in order to solve the above-mentioned problems, and provides a charge/discharge control circuit capable of reducing the layout area and reducing a leakage current flowing when the charge/discharge control circuit is OFF, and also provides a battery device including the charge/discharge control circuit.

In order to solve the conventional problems, a battery device including a charge/discharge control circuit according to the present invention has the following configuration.

The present invention provides a charge/discharge control circuit for controlling charge/discharge of a secondary battery by a single bidirectionally conductive field effect transistor, the charge/discharge control circuit including: a control circuit connected to both ends of the secondary battery, for monitoring a voltage of the secondary battery; a switch circuit including a first terminal and a second terminal, for controlling a gate of the bidirectionally conductive field effect transistor based on an output of the control circuit; a first PN junction element connected to the first terminal of the switch circuit and a drain of the bidirectionally conductive field effect transistor; and a second PN junction element connected to the first terminal of the switch circuit and a source of the bidirectionally conductive field effect transistor.

According to the battery device including the charge/discharge control circuit of the present invention, the number of elements to be used can be reduced to reduce the layout area. Besides, the present invention uses a Schottky barrier diode as a diode, and hence provides an effect that the leakage current can be reduced.

### BRIEF DESCRIPTION OF THE DRAWINGS

In the accompanying drawings:

FIG. 1 is a circuit diagram of a battery device including a charge/discharge control circuit according to a first embodiment of the present invention;

FIG. 2 is a circuit diagram of a battery device including a charge/discharge control circuit according to a second embodiment of the present invention; and

FIG. 3 is a circuit diagram of a battery device including a conventional charge/discharge control circuit.

### DETAILED DESCRIPTION OF THE PREFERRED EMBODIMENTS

Referring to the accompanying drawings, embodiments of the present invention are described below.

### FIRST EMBODIMENT

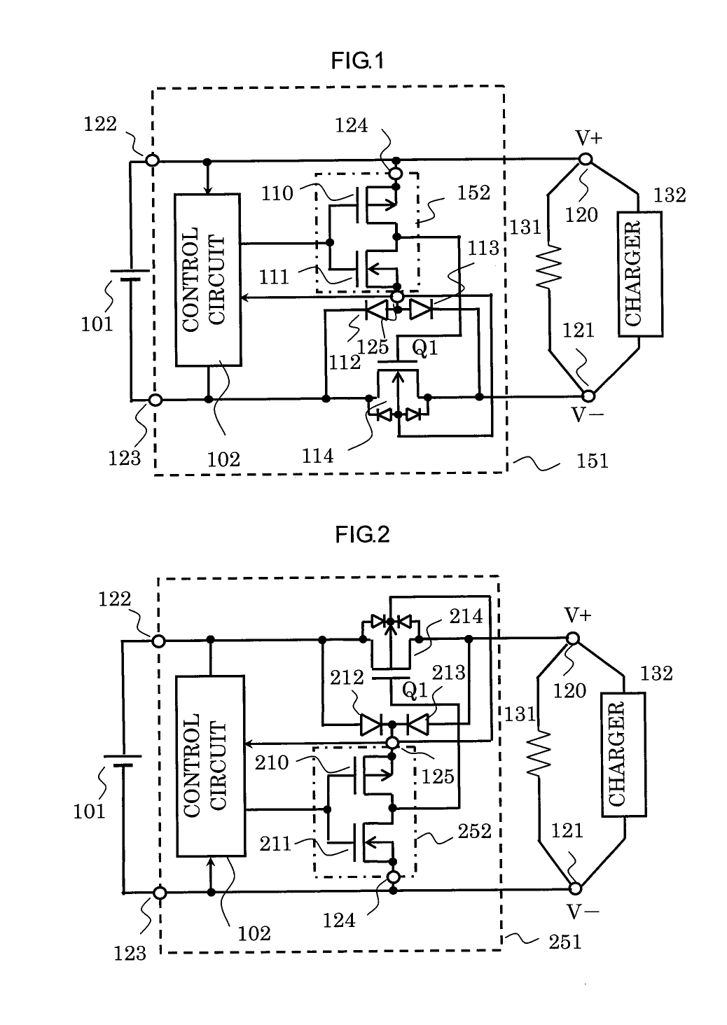

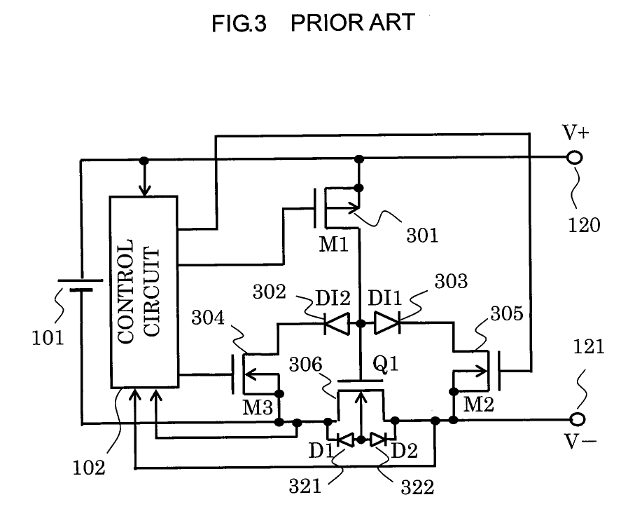

FIG. 1 is a circuit diagram of a battery device including a charge/discharge control circuit 151 according to a first embodiment of the present invention.

The battery device including the charge/discharge control circuit 151 of this embodiment includes a secondary battery 101, a control circuit 102, a bidirectionally conductive field effect transistor 114, external terminals 120 and 121 between which a charger 132 or a load 131 is to be connected, Schottky barrier diodes 112 and 113, a PMOS transistor 110, and an NMOS transistor 111. The PMOS transistor 110, the NMOS transistor 111, a terminal 124 (second terminal), and a terminal 125 (first terminal) together form a switch circuit 152.

The secondary battery 101 has both ends connected to a positive power supply terminal 122 and a negative power supply terminal 123, respectively. The control circuit 102 is connected to the positive power supply terminal 122 as positive power supply and to the terminal 125 as negative power supply. The control circuit 102 has an output connected to a gate of the PMOS transistor 110 and a gate of the NMOS transistor 111. The PMOS transistor 110 has a source connected to the positive power supply terminal 122 and the external terminal 120 via the terminal 124, and a drain connected to a drain of the NMOS transistor 111. The NMOS transistor 111 has a source connected to an anode of the Schottky barrier diode 112 and an anode of the Schottky barrier diode 113 via the terminal 125. The NMOS transistor 111 has the drain also connected to a gate of the bidirectionally conductive field effect transistor 114, and a back gate connected to the anode of the Schottky barrier diode 112 and the anode of the Schottky barrier diode 113. The Schottky barrier diode 112 has a cathode connected to the negative power supply terminal 123. The Schottky barrier diode 113 has a cathode connected to the external terminal 121. The bidirectionally conductive field effect transistor 114 has a drain connected to the negative power supply terminal 123, a source connected to the external terminal 121, and a back gate connected to the terminal 125.

Next, an operation of the battery device including the charge/discharge control circuit 151 according to this embodiment is described.

When the charger 132 is connected between the external terminals 120 and 121 and the control circuit 102 detects that the secondary battery 101 is in a chargeable/dischargeable state, the control circuit 102 outputs Low to turn ON the PMOS transistor 110 and OFF the NMOS transistor 111. Then, the gate electrode of the bidirectionally conductive field effect transistor 114 is connected to the positive power supply terminal 122, and the bidirectionally conductive field effect transistor 114 enters an ON state. This way, charge/discharge is performed. The negative power supply of the control circuit 102 is connected to the terminal 125, and hence a lower one of the voltage at the negative power supply terminal 123 and the voltage at the external terminal 121 can be output as Low.

When the charger 132 is connected between the external terminals 120 and 121 and the control circuit 102 detects that the secondary battery 101 has entered a charge-inhibited state, the control circuit 102 outputs High to turn OFF the PMOS transistor 110 and ON the NMOS transistor 111. Then, the gate electrode of the bidirectionally conductive field effect transistor 114 is pulled down to the external terminal 121 via the Schottky barrier diode 113, the terminal 125, and the NMOS transistor 111. The bidirectionally conductive field effect transistor 114 then enters the OFF state. This way, a charge current is interrupted to prevent overcharge of the secondary battery 101. Further, the Schottky barrier diode 112 is reverse-biased to prevent the current from flowing from the negative power supply terminal 123 to the external terminal 121. In this case, the present invention uses a Schottky barrier diode having a low VF voltage (about 0.3 V), which can reduce the gate-source voltage of the bidirectionally conductive field effect transistor 114 to reduce an OFF-state leakage current. Further, the back gate terminal of the bidirectionally conductive field effect transistor 114 does not become a floating state, which enables more stable operation of the charge/discharge control circuit 151.

When the load 131 is connected between the external terminals 120 and 121 and the control circuit 102 detects that the secondary battery 101 has entered a discharge-inhibited state, the control circuit 102 outputs High to turn OFF the PMOS transistor 110 and ON the NMOS transistor 111. Then, the gate electrode of the bidirectionally conductive field effect transistor 114 is pulled down to the negative power supply terminal 123 via the Schottky barrier diode 112, the terminal 125, and the NMOS transistor 111. The bidirectionally conductive field effect transistor 114 then enters the OFF state. This way, a discharge current is interrupted to prevent overdischarge of the secondary battery 101. Further, the Schottky barrier diode 113 is reverse-biased to prevent the current from flowing from the external terminal 121 to the negative power supply terminal 123. In this case, the present invention uses a Schottky barrier diode having a low VF voltage (about 0.3 V), which can reduce the gate-source voltage of the bidirectionally conductive field effect transistor 114 to reduce the OFF-state leakage current. Further, the back gate terminal of the bidirectionally conductive field effect transistor 114 does not become a floating state, which enables more stable operation of the charge/discharge control circuit 151.

As described above, according to the battery device including the charge/discharge control circuit 151 of this embodiment, the leakage current flowing through the bidirectionally conductive field effect transistor 114 can be reduced in either case where the secondary battery 101 has entered the charge-inhibited state or the discharge-inhibited state. In addition, by controlling the back gate of the bidirectionally conductive field effect transistor 114, the charge/discharge control circuit 151 can be operated stably.

Note that, the bidirectionally conductive field effect transistor 114 may be externally connected to the charge/discharge control circuit 151. Further, although not illustrated, also in a configuration in which the back gate terminal of the bidirectionally conductive field effect transistor 114 is not connected to the terminal 125, the leakage current flowing through the bidirectionally conductive field effect transistor 114 can be reduced.

### SECOND EMBODIMENT

FIG. 2 is a circuit diagram of a battery device including a charge/discharge control circuit 251 according to a second embodiment of the present invention.

The battery device including the charge/discharge control circuit 251 of the second embodiment includes a secondary battery 101, a control circuit 102, a bidirectionally conductive field effect transistor 214, external terminals 120 and 121 between which a charger 132 or a load 131 is to be connected, Schottky barrier diodes 212 and 213, a PMOS transistor 210, and an NMOS transistor 211. The PMOS transistor 210, the NMOS transistor 211, a terminal 124 (second terminal), and a terminal 125 (first terminal) together form a switch circuit 252.

The secondary battery 101 has both ends connected to a positive power supply terminal 122 and a negative power supply terminal 123, respectively. The control circuit 102 is connected to the terminal 125 as positive power supply and to the negative power supply terminal 123 as negative power supply. The control circuit 102 has an output connected to a gate of the PMOS transistor 210 and a gate of the NMOS transistor 211. The PMOS transistor 210 has a source and a back gate which are connected to a cathode of the Schottky barrier diode 212 and a cathode of the Schottky barrier diode 213 via the terminal 125. The PMOS transistor 210 has a drain connected to a drain of the NMOS transistor 211. The NMOS transistor 211 has a source connected to the negative power supply terminal 123 and the external terminal 121 via the terminal 124. The NMOS transistor 211 has the drain also connected to a gate of the bidirectionally conductive field effect transistor 214. The Schottky barrier diode 212 has an anode connected to the positive power supply terminal 122. The Schottky barrier diode 213 has an anode connected to the external terminal 120. The bidirectionally conductive field effect transistor 214 has a drain connected to the positive power supply terminal 122, a source connected to the external terminal 120, and a back gate connected to the terminal 125.

Next, an operation of the battery device including the charge/discharge control circuit 251 according to the second embodiment is described.

When the charger 132 is connected between the external terminals 120 and 121 and the control circuit 102 detects that the secondary battery 101 is in a chargeable/dischargeable state, the control circuit 102 outputs High to turn OFF the PMOS transistor 210 and ON the NMOS transistor 211. Then, the gate electrode of the bidirectionally conductive field effect transistor 214 is connected to the negative power supply terminal 123, and the bidirectionally conductive field effect transistor 114 enters an ON state. This way, charge/discharge is performed. The positive power supply of the control circuit 102 is connected to the terminal 125, and hence a higher one of the voltage at the positive power supply terminal 122 and the voltage at the external terminal 120 can be output as High.

When the charger 132 is connected between the external terminals 120 and 121 and the control circuit 102 detects that the secondary battery 101 has entered a charge-inhibited state, the control circuit 102 outputs Low to turn ON the PMOS transistor 210 and OFF the NMOS transistor 211. Then, the gate electrode of the bidirectionally conductive field effect transistor 214 is pulled up to the external terminal 120 via the Schottky barrier diode 213, the terminal 125, and the PMOS transistor 210. The bidirectionally conductive field effect transistor 214 then enters the OFF state. This way, a charge current is interrupted to prevent overcharge of the secondary battery 101. Further, the Schottky barrier diode 212 is reverse-biased to prevent the current from flowing from the external terminal 120 to the positive power supply terminal 122. In this case, the present invention uses a Schottky barrier diode having a low VF voltage (about 0.3 V), which can reduce the gate-source voltage of the bidirectionally conductive field effect transistor 214 to reduce an OFF-state leakage current. Further, the back gate terminal of the bidirectionally conductive field effect transistor 214 does not become a floating state, which enables more stable operation of the charge/discharge control circuit 251.

When the load 131 is connected between the external terminals 120 and 121 and the control circuit 102 detects that the secondary battery 101 has entered a discharge-inhibited state, the control circuit 102 outputs Low to turn ON the PMOS transistor 210 and OFF the NMOS transistor 211. Then, the gate electrode and the back gate of the bidirectionally conductive field effect transistor 214 are pulled up to the positive power supply terminal 122 via the Schottky barrier diode 212, the terminal 125, and the PMOS transistor 210. The bidirectionally conductive field effect transistor 214 then enters the OFF state. This way, a discharge current is interrupted to prevent overdischarge of the secondary battery 101. Further, the Schottky barrier diode 213 is reverse-biased to prevent the current from flowing from the positive power supply terminal 122 to the external terminal 120. In this case, the present invention uses a Schottky barrier diode having a low VF voltage (about 0.3 V), which can reduce the gate-source voltage of the bidirectionally conductive field effect transistor 214 to reduce the OFF-state leakage current. Further, the back gate terminal of the bidirectionally conductive field effect transistor 214 does not become a floating state, which enables more stable operation of the charge/discharge control circuit 251.

As described above, according to the battery device including the charge/discharge control circuit 251 of the second embodiment, the leakage current flowing through the bidirectionally conductive field effect transistor 214 can be reduced in either case where the secondary battery 101 has entered the charge-inhibited state or the discharge-inhibited state. In addition, by controlling the back gate of the bidirectionally conductive field effect transistor 214, the charge/discharge control circuit 251 can be operated stably.

Note that, the bidirectionally conductive field effect transistor 214 may be externally connected to the charge/discharge control circuit 251. Further, although not illustrated, also in a configuration in which the back gate terminal of the bidirectionally conductive field effect transistor 214 is not connected to the terminal 125, the leakage current flowing through the bidirectionally conductive field effect transistor 214 can be reduced.

What is claimed is:

1. A charge/discharge control circuit for controlling charge/discharge of a secondary battery by a single bidirectionally conductive field effect transistor,
the charge/discharge control circuit comprising:
a control circuit connected to both ends of the secondary battery, for monitoring a voltage of the secondary battery;
a switch circuit including a first terminal and a second terminal, for controlling a gate of the bidirectionally conductive field effect transistor based on an output of the control circuit;
a first PN junction element connected to the first terminal of the switch circuit and a drain of the bidirectionally conductive field effect transistor; and
a second PN junction element connected to the first terminal of the switch circuit and a source of the bidirectionally conductive field effect transistor.

2. A charge/discharge control circuit according to claim 1, wherein each of the first PN junction element and the second PN junction element comprises a Schottky barrier diode.

3. A charge/discharge control circuit according to claim 1, wherein the bidirectionally conductive field effect transistor includes a back gate connected to the first terminal of the switch circuit.

4. A charge/discharge control circuit according to claim 1, wherein the switch circuit comprises:
a P-channel MOS transistor including a gate connected to the output of the control circuit, a drain connected to the gate of the bidirectionally conductive field effect transistor, and a source connected to the second terminal; and
an N-channel MOS transistor including a gate connected to the output of the control circuit, a drain connected to the gate of the bidirectionally conductive field effect transistor, and a source connected to the first terminal.

5. A charge/discharge control circuit according to claim 4, wherein the control circuit includes a negative power supply terminal connected to the first terminal of the switch circuit.

6. A charge/discharge control circuit according to claim 1, wherein the switch circuit comprises:
a P-channel MOS transistor including a gate connected to the output of the control circuit, a drain connected to the gate of the bidirectionally conductive field effect transistor, and a source connected to the first terminal; and
an N-channel MOS transistor including a gate connected to the output of the control circuit, a drain connected to the gate of the bidirectionally conductive field effect transistor, and a source connected to the second terminal.

7. A charge/discharge control circuit according to claim 6, wherein the control circuit includes a positive power supply terminal connected to the first terminal of the switch circuit.

8. A battery device, comprising:
a chargeable/dischargeable secondary battery;
a single bidirectionally conductive field effect transistor serving as a charge/discharge control switch, which is provided in a charge/discharge path of the chargeable/dischargeable secondary battery; and
the charge/discharge control circuit according to claim 1, for monitoring a voltage of the chargeable/dischargeable secondary battery to open/close the charge/discharge control switch, to thereby control charge/discharge of the chargeable/dischargeable secondary battery.
